(19) United States
(12) Patent Application Publication
(10) Pub. No.: US 2005/0197999 A1
(43) Pub. Date: Sep. 8, 2005

(54) System and method for task management

(75) Inventor: Ankesh Kumar, Palo Alto, CA (US)

Correspondence Address: Steven M. Haas;Fay, Sharpe, Fagan, Minnich & McKee, LLP, Seventh Floor, 1100 Superior Avenue, Cleveland, OH, 44114-2518, US

(73) Assignee: APPMAIL LLC

(21) Appl. No.: 11/028,691

(22) Filed: Jan. 4, 2005

Related U.S. Application Data
(63) Continuation-in-part of application No. 10/862,727, filed on Jun. 7, 2004.
Application No. 10/862,727 is a continuation-in-part of application No. 10/307,188, filed on Nov. 29, 2002.
(60) Provisional application No. 60/333,705, filed on Nov. 28, 2001.

(51) Int. Cl. G06F 7/00

(52) U.S. Cl. 707/1

(57) ABSTRACT

A task management method includes receiving appmail definition data relating to a task from a task manager. The appmail definition data include question data defining a question relating to a task and structured response data defining a plurality of different structured responses to the question. A task appmail is generated based upon the appmail definition data received from the task manager. The task appmail defines a questionnaire including the question and the plurality of different structured responses. The task appmail comprises a data file that defines the questions and the plurality of structured responses to the question, and wherein the data file further defines a plurality of different user-selectable fields associated respectively with the plurality of structured responses when said task appmail is displayed to a user on a computer screen. The task appmail is sent to a task member by e-mail. A completed task appmail is received from the task member. The completed task appmail includes response data that represent the one of the different structured responses to the question selected by the task member using one of the plurality of different user-selectable fields. The response data are saved in a database and are used to generate a task report for the task manager.

### CROSS-REFERENCE TO RELATED APPLICATIONS

This application is a continuation-in-part of co-pending U.S. application Ser. No. 10/862,727 filed Jun. 7, 2004, which is a continuation-in-part of U.S. application Ser. No. 10/307,188 filed Nov. 29, 2002, which claims benefit of the filing date of and priority from U.S. provisional application No. 60/333,705 filed Nov. 28, 2001, and all of said applications (U.S. application Ser. No. 10/862,727 filed Jun. 7, 2004, U.S. application Ser. No. 10/307,188 filed Nov. 29, 2002, and U.S. provisional application No. 60/333,705 filed Nov. 28, 2001) are hereby expressly incorporated by reference into this specification.

### BACKGROUND OF THE INVENTION

The present development relates to a system and method for task management. It is described herein with reference to specific examples, but those of ordinary skill in the art will recognize that the present development is suitable for use in connection with any task or process or survey that requires a computer user to collect structured and unstructured response data from one or many computer users for purpose of task management, performance tracking, reporting, compliance, etc.

Conventional systems and methods for computerized task management are deficient for a variety of reasons. Dedicated task management software is often undesirable in that it is system dependent (and project team members often use different systems), requires purchase, installation, maintenance and training in the use of a dedicated software package, and requires that users launch and use yet another software package in connection with fulfilling their business and/or personal task management duties.

The drawbacks of dedicated task management software, combined with the ease-of-use and ubiquitous nature of conventional electronic mail (e-mail), many supervisors and other task managers use e-mail as an ad-hoc computer-implemented task management solution. Conventional e-mail is ill-suited for task management for many reasons. A main drawback to e-mail, especially when multiple computer users must provide input on a task, is its “many-to-one” nature, where a task manager sends out a single e-mail to multiple recipients requesting task management input, but receives back a response from each recipient and must then collate the responses in some fashion to derive usable project management data. Another defect associated with use of e-mail for task management is that responses of the recipients are unstructured. For example, a sales manager, desiring an exact number is response, might send an e-mail reading “How many sales calls did you make this week?” The recipients might respond “a lot” “more than last week” “I was sick this week” or might provide the preferred numeric response such as “10.” A problem associated with use of e-mail for task management is the inability to send the e-mail with parameters designed to encourage a timely response, such as automatic re-sends/reminders. As such, a task management e-mail can easily drift to the bottom of the recipient's inbox while the sender awaits a response. In such case, the sender must manually re-send the e-mail and/or a reminder note. Additionally, with conventional e-mail, the task manager must manually and individually extract the response data from the response e-mails and use same to generate a report for planning and/or recording purposes. In some cases, it is critical to document the task management e-mails and responses and, in such cases, conventional e-mail is suboptimal in that the task managers original e-mail and/or the responses thereto can be altered.

In light of theses deficiencies and others associated with conventional task management software and use of conventional e-mail for task management, it has been deemed necessary to provide a system and method for task management that is e-mail based, but that incorporates advanced features and methods intended to overcome the above-described deficiencies of the prior art while providing better overall results.

### SUMMARY OF THE INVENTION

In accordance with a first aspect of the present development, a task management method includes receiving appmail definition data relating to a task from a task manager. The appmail definition data include question data defining a question relating to a task and structured response data defining a plurality of different structured responses to the question. A task appmail is generated based upon the appmail definition data received from the task manager. The task appmail defines a questionnaire including the question and the plurality of different structured responses. The task appmail comprises a data file that defines the questions and the plurality of structured responses to the question, and wherein the data file further defines a plurality of different user-selectable fields associated respectively with the plurality of structured responses when said task appmail is displayed to a user on a computer screen. The task, appmail is sent to a task member by e-mail. A completed task appmail is received from the task member. The completed task appmail includes response data that represent the one of the different structured responses to the question selected by the task member using one of the plurality of different user-selectable fields. The response data are saved in a database and are used to generate a task report for the task manager.

### BRIEF DESCRIPTION OF THE DRAWINGS

The present invention comprises various systems and methods, preferred embodiments of which are illustrated in the accompanying drawings that form a part hereof and wherein:

FIG. 1 is a diagrammatic illustration of a system formed in accordance with the present invention;

FIG. 2 is a flow chart that discloses a process for creating a task appmail in accordance with the present invention;

FIG. 2A is an example screen shot of an appmail inbox defined in accordance with the present invention;

FIG. 2B is a flow chart that discloses a process for defining a new task appmail in accordance with the present invention;

FIGS. 2C-2K are respective example screen shots of various computer displayed screens that are presented to a task manager during the process of FIG. 2B;

FIG. 3 is a flow chart that discloses a process by which a task member responds to a task appmail;

FIGS. 4A and 4B show examples of a task appmail as displayed on a task members computer screen in accordance with the present invention;

FIG. 5 is a diagram that generally illustrates the process of generating and using an APPMAIL in accordance with the present invention;

FIGS. 6A, 6B and 6C illustrate a task report as generated by the appmail engine and displayed on a task managers computer screen in accordance with the present invention.

### DETAILED DESCRIPTION OF THE INVENTION

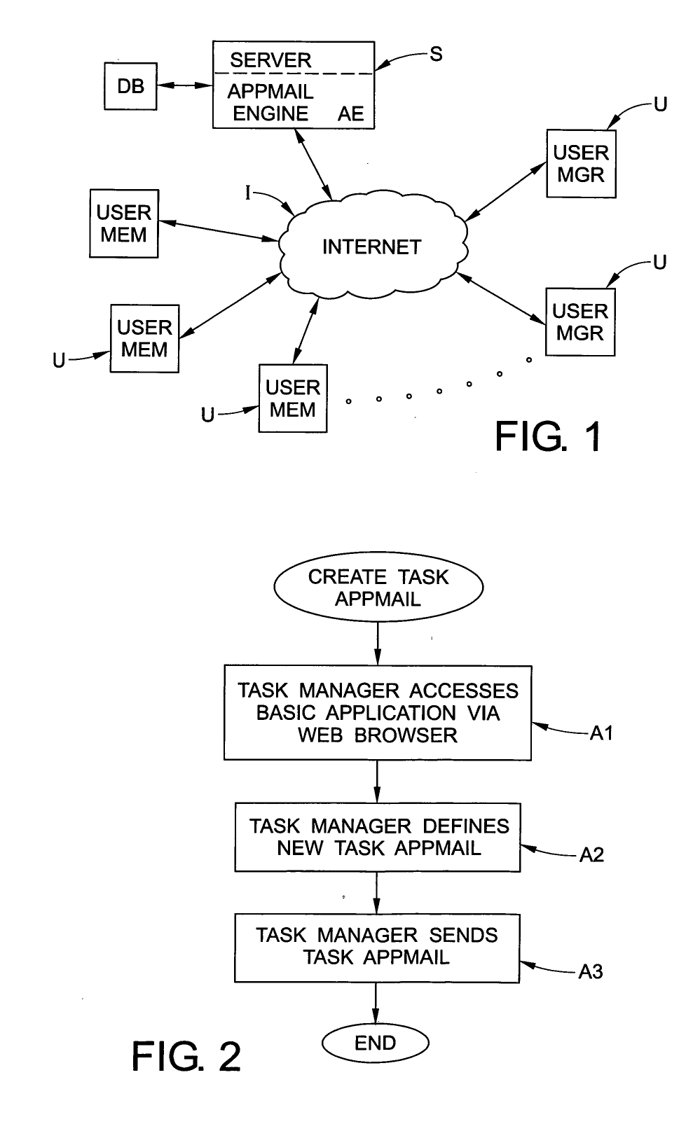

FIG. 1 diagrammatically illustrates a web-based computer system for multiple computers or other electronic devices U, e.g., pda's, web-enabled telephones, etc., to send data to and receive data from a server S (that comprises one or more computers) via the internet I or another computer network. The user devices U are connected to the internet or other network via wired or wireless connections(s) and/or combinations thereof. The server S comprises and/or is connected to database system DB that stores and allows authorized user devices U to obtain controlled/structured access to data for reading and/or writing operations as is also well-known in the art. In accordance with the present development, however, the server S is programmed to implement a novel and unobvious computer software application, referred to herein as the appmail engine AE, alone or as part of a related basic application. The appmail engine operates in conjunction with electronic mail (e-mail) to provide a new system and method for task management.

In accordance with the present development, the server S is running a task management application program (also referred to as “the basic application”) that incorporates or interfaces with the appmail engine AE. In the embodiment described herein, the basic application is an html web-based application that receives input from a task manager as described herein to define, send and manage task appmails and to report the results of same. The user devices U are each allowed a level of access with respect to the server S and the basic application (if any) depending upon the authority assigned to (the human user of) those devices U. The human user of a device U can be a task member MEM who is assigned to a task or sub-task and interacts with the basic application via e-mail only through the appmail engine AE; a task manager MGR who uses basic application directly through a web browser or otherwise (e.g., e-mail) to control the basic application (and consequently the appmail engine AE) in order to create tasks and sub-tasks and assigns task members MEM to same.

As described hereinbelow, the system and method of the present invention allow task members MEM to interface with the basic application and appmail engine AE, even though these task members MEM cannot directly access and use the basic application running on server S. This is accomplished by sending each task member MEM a task “appmail” via e-mail and, thereafter, receiving a completed task appmail from the task member MEM in reply. The completed task appmail is parsed to extract structured data and, if present, unstructured data therefrom, and these data are input to the database DB for use by the basic application to generate reports or for other purposes and/or any other application or process. The task appmail is a computer implemented questionnaire/survey.

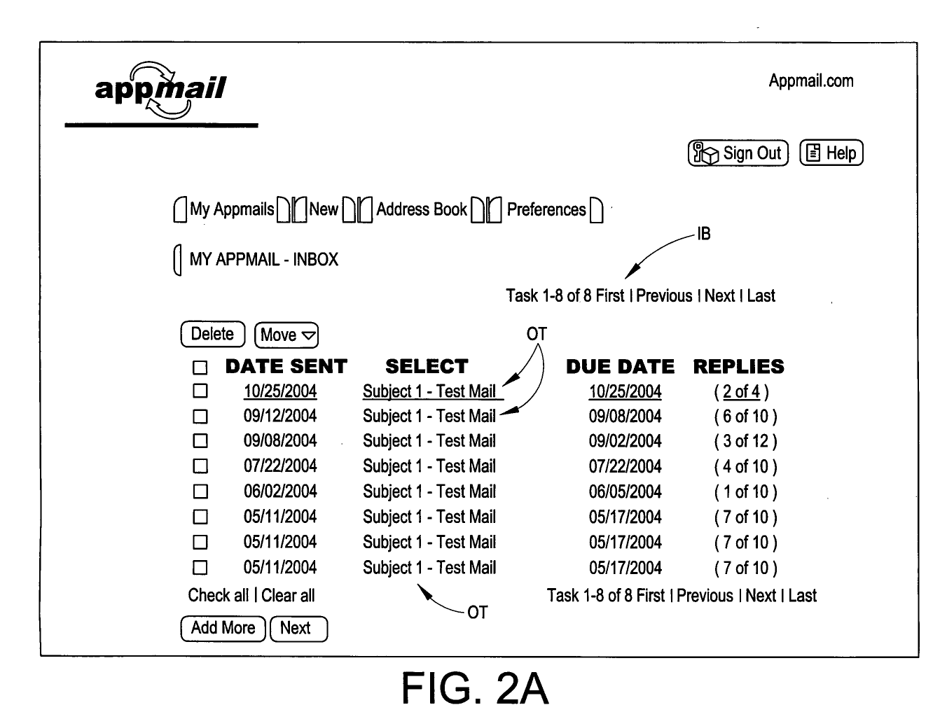

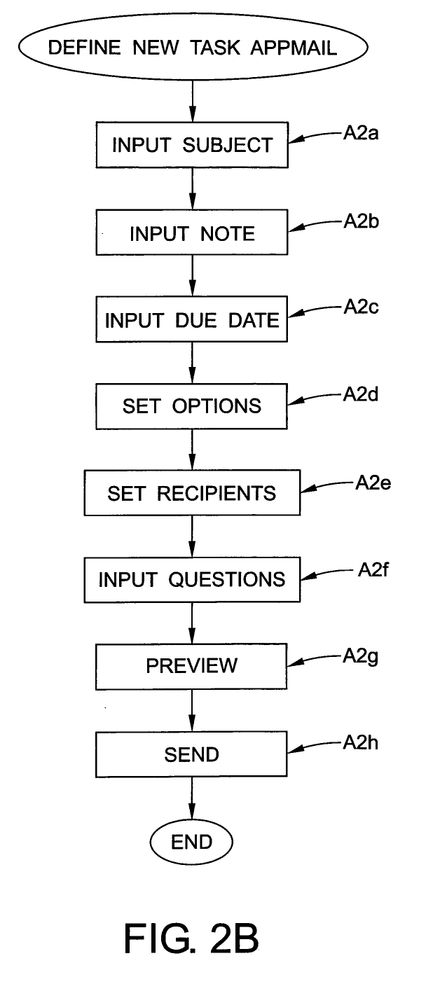

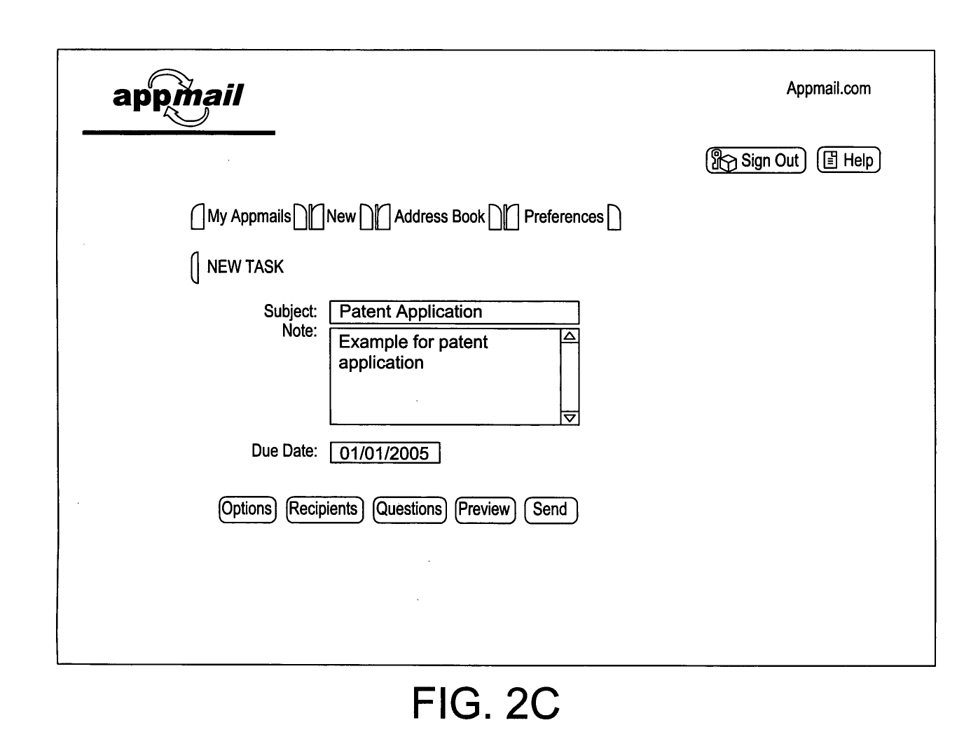

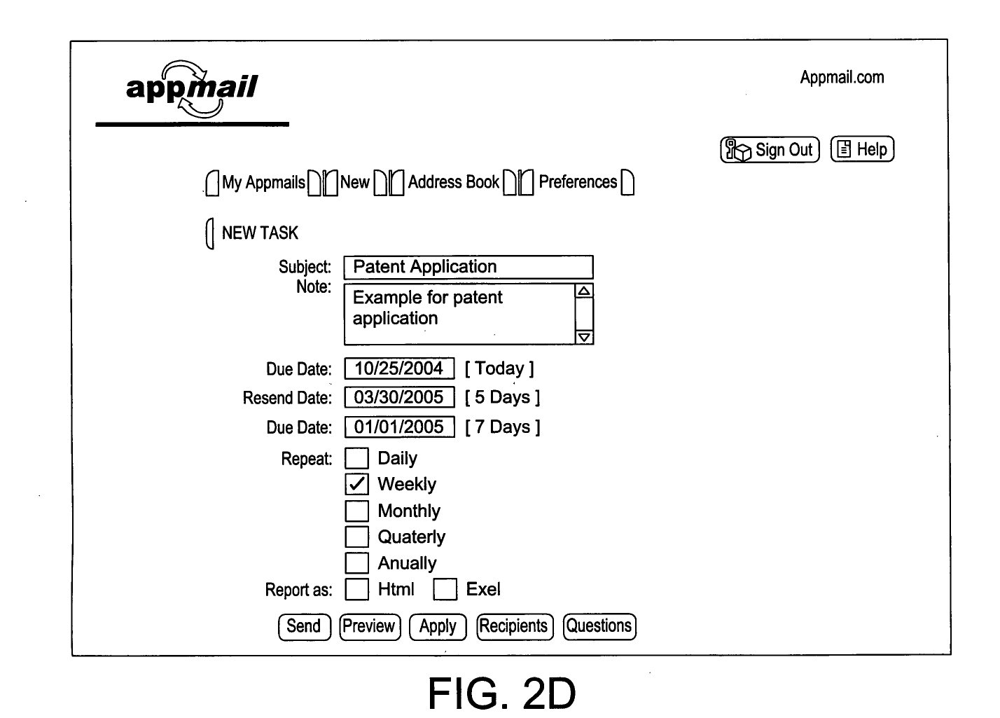

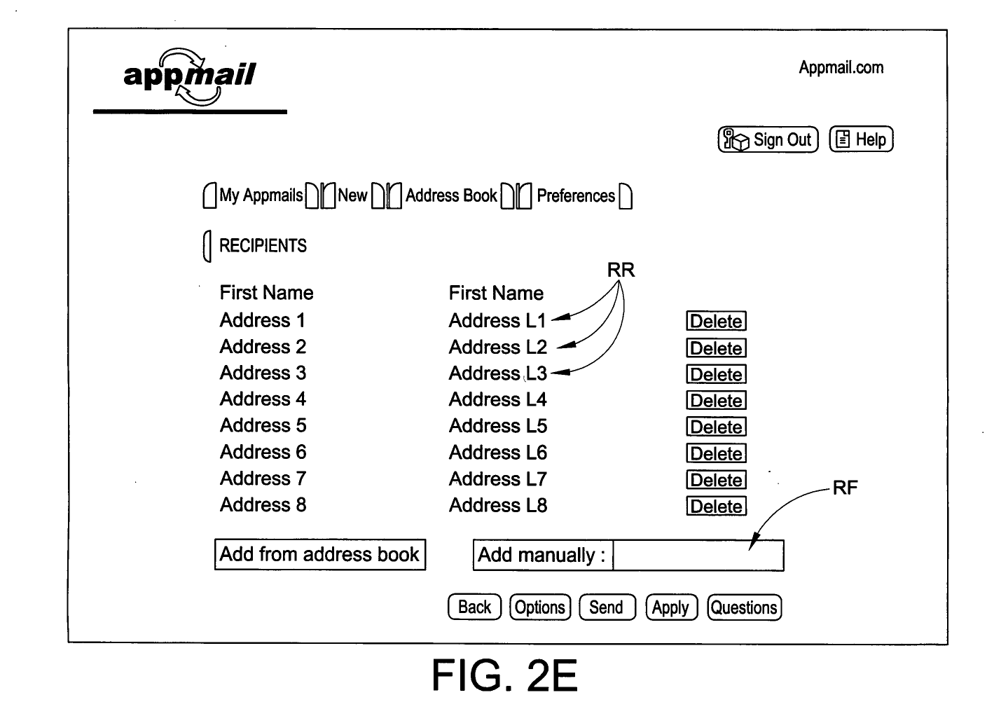

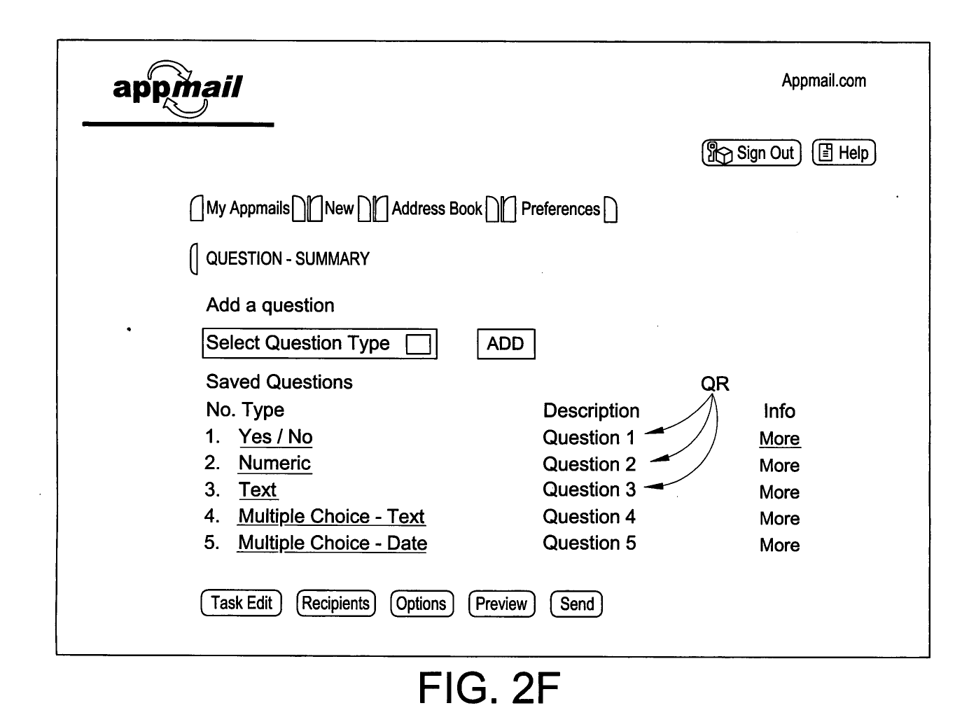

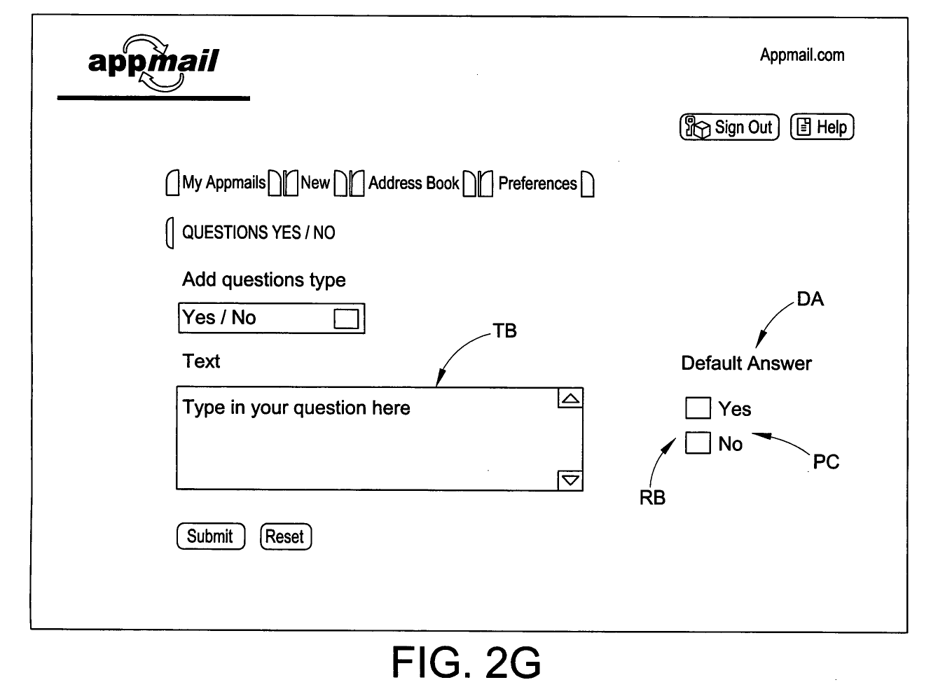

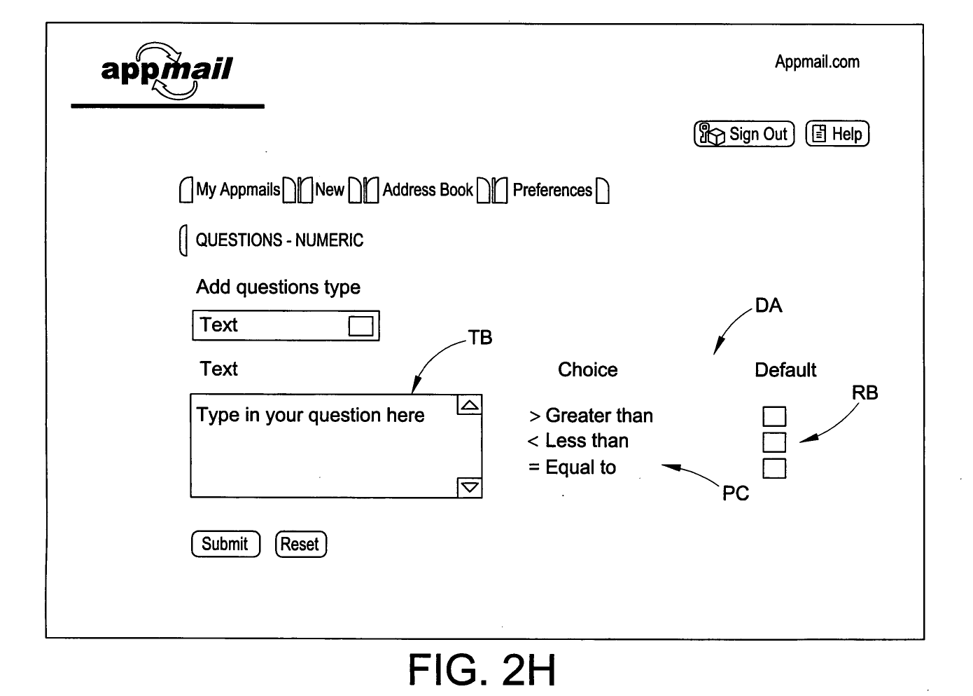

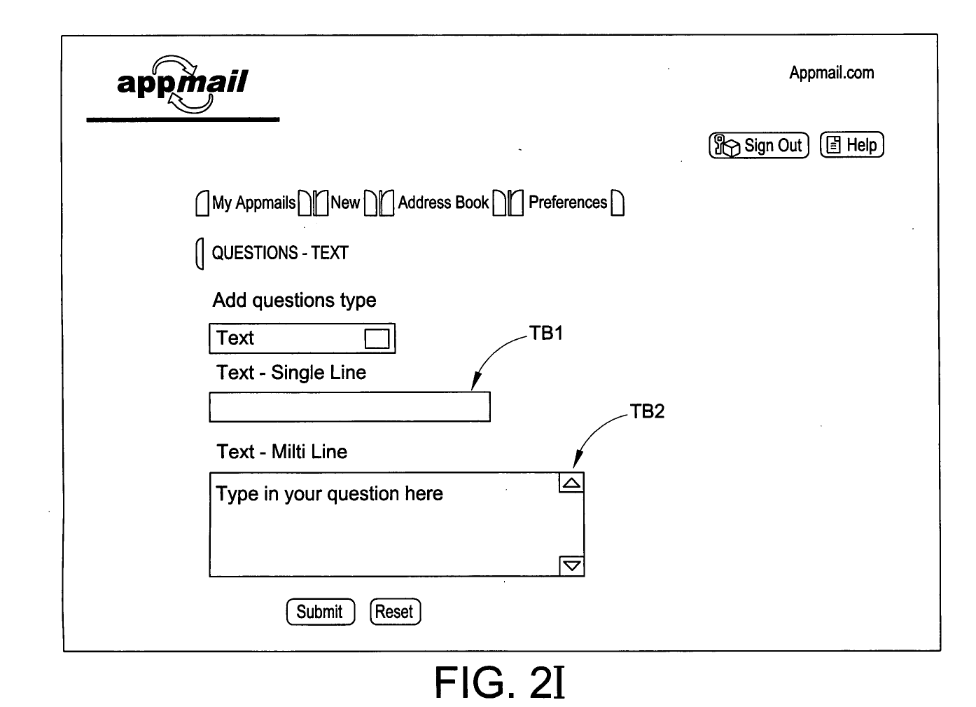

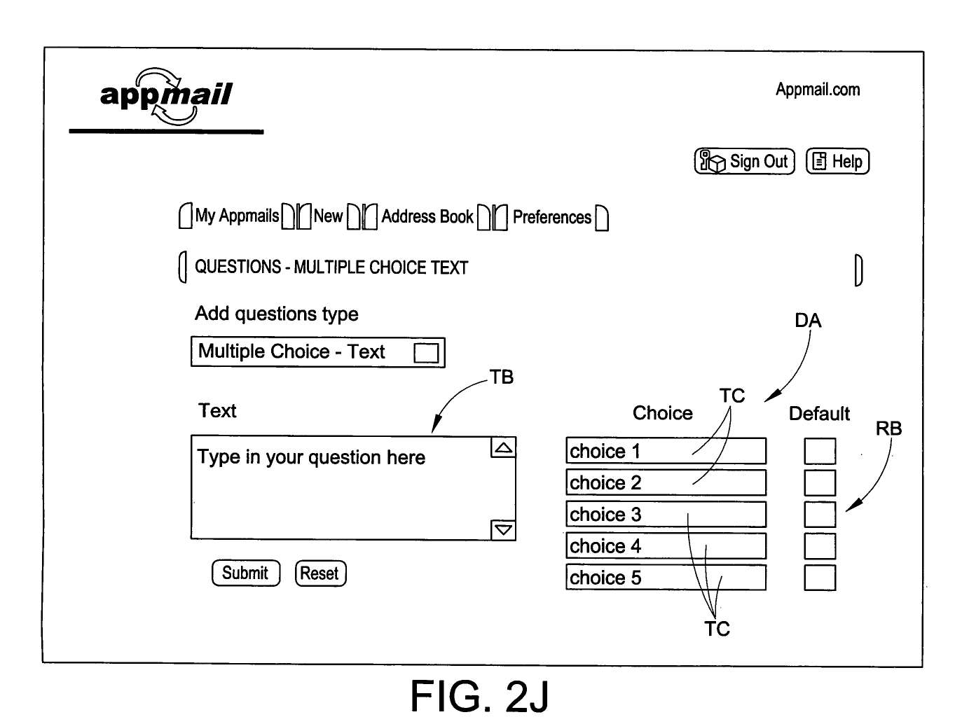

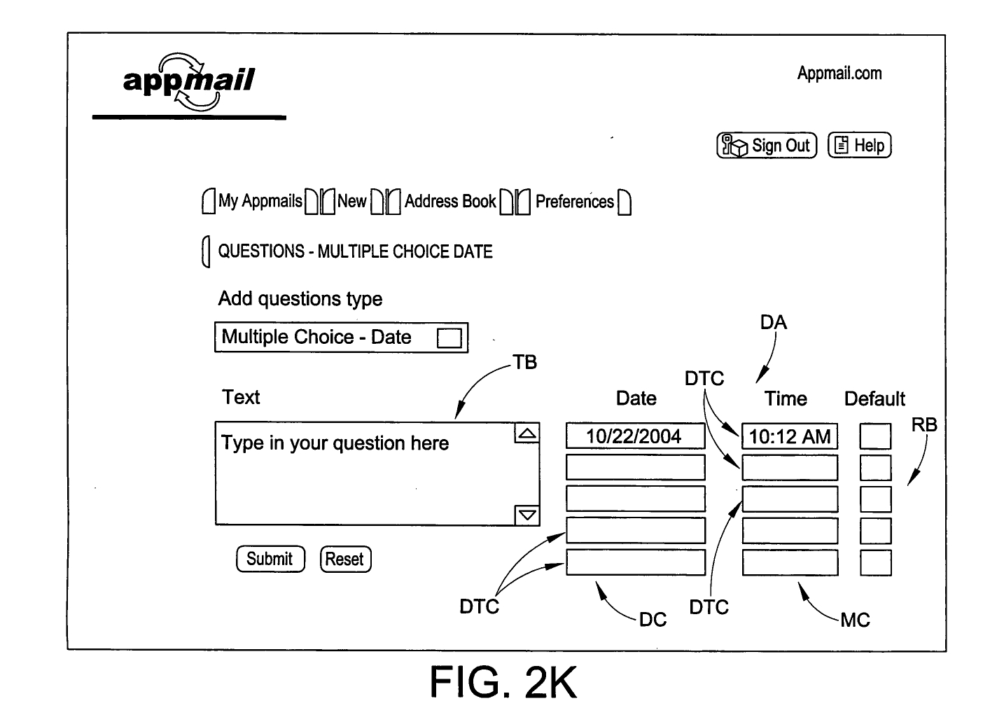

FIG. 2 is a flow chart that discloses a process by which a task manager MGR creates a new task appmail. The task appmail can relate to a stand-alone task or a sub-task to another task. In a step A1, the task manager MGR accesses the basic application, i.e., the task management application running on server S, using a web browser and using a username and password (i.e., a login process) in standard fashion as is well known in the art of web-based computing. In a step A2, the task manager MGR defines a new task appmail (with or without optional sub-tasks) including the recipient task members MEM using the basic application and appmail engine AE via his/her web browser. In a step A3, the task manager MGR sends the task appmail to these assigned task members MEM.

More particularly, upon a successful login to the basic application in the step A1, the task manager MGR is presented with an inbox IB as shown in FIG. 2A. The inbox IB sets forth a listing of all open task appmails OT previously created by the task manager. In the illustrated embodiment, each open task appmail is defined by an inbox record defined by a “Date Sent” field that indicates the date the task appmail was sent to the assigned task members MEM; a “Subject” field that sets forth the subject of the task appmail as input by the task manager MGR during creation of the task appmail (as described further below); a “Due Date” field that sets forth data that indicate the due date assigned to the task appmail by the task manager MGR during creation of the task appmail; and a “Replies” field that indicates the number of replies received from the task members MEM out of the total number of recipients of the task appmail. The task manager MGR can review the details of the each task appmail by selecting any of these fields in the open task appmail record with a mouse or other pointing device or otherwise, e.g., by highlighting the record with a cursor and selecting “enter.” In one embodiment, when the task manager MGR selects the “Date Sent” or “Subject” or “Due Date” fields of a task appmail record, the task manager MGR is presented with details about the task appmail, and when the task manager MGR selects the “Replies” field, the manager is presented with a report that details and/or summarizes the replies received thus far. If a task appmail includes related sub-task appmails, these are revealed in a tree-like directory fashion below the task appmail and are otherwise the same as a task appmail.

FIG. 2B provides a flow chart that details step A2 of FIG. 2, i.e., the process by which a task manager MGR defines a new task appmail. In steps A2a, A2b,A2c, the task manager MGR inputs a subject, note, and due date for the task appmail being defined. FIG. 2C illustrates an example “New Task” web screen by which the steps A2a,A2b,A2c are carried out. In particular, the task manager MGR is presented with a screen on his/her browser such as that shown in FIG. 2C and the task manager uses a mouse, keyboard, stylus, and/or other input device(s) to input a subject in the “Subject” field, a descriptive note in the “Note’ field, and a response due date in the “Due Date”′ field.

The “Set Options” step A2d of FIG. 2B is carried out when the task manager MGR selects the “Options” button from the “New Task” screen shown in of FIG. 2C. When the “Options” button is selected, a “Task Option” screen, such as that shown in FIG. 2D is presented. Using the “Task Option” screen, the task manager MGR can input options for the task appmail being created. The “Task Option” screen is prepopulated with the “Subject,” “Note” and “Due Date” fields as input by the task manager MGR to the “New Task” screen shown in FIG. 2C. Using a mouse, stylus, keyboard and/or other input device, the task manager MGR interacts with the “Task Option” screen shown in FIG. 2D to set additional options/parameters for the task appmail being defined. More particularly, the task manager MGR can input a date in the “Send Date” field. The date input to the “Send Date” field is the date on which the new task appmail will be sent automatically to the assigned task member recipients (default=today's date). The task manager MGR can input a date in the “Resend Date” field. The date input to the “Resend Date” field is the date on which the new task appmail will be resent automatically to the assigned task member recipients who haven't yet responded (default=five days from send date). The task manager MGR can input a date in the “Due Date” field. The date input to the “Due Date” field is the date on which all responses from the assigned task member recipients will be due (default=seven days from send date).

Often, a task manager MGR will desire to receive input on a particular aspect of a task from assigned task members MEM on a regular, periodic basis, without having to redefine and resend the same task appmail over and over again. To this end, as shown in FIG. 2D, the “Task Option” screen preferably also comprises a “Repeat” field including a plurality of predefined repeat interval choices, any one of which that can be optionally selected by the task manager using his/her input device in order to set a repeat interval at which the task appmail being defined will be sent again to the assigned task member recipients. As shown the repeat choices are daily, weekly, monthly, quarterly, or annually, and the task manager MGR can select any one or none of these fields. The task appmail being defined, with all options, with be resent to the assigned task member recipients MEM at the selected interval.

A main feature of the present development is that the appmail engine AE generates reports based upon the responses (or lack of responses) received from the assigned task members MEM with respect to every task appmail sent. The “Task Option” screen as shown in FIG. 2D includes a “Report As” field that allows the task manager to select at least one of a plurality of different file formats in which the task report for the task appmail will be generated by the appmail engine AE. In the illustrated example, the task manager can select the report as either an HTML file or an spreadsheet (e.g., Excel) file. The appmail engine AE generates the report accordingly and sends the reports to the task manager MGR by e-mail and/or makes the reports otherwise available to the task manager by an html link or otherwise, e.g., through the “Replies” field link for a task appmail record in the Inbox of FIG. 2A.

Once the task manager MGR sets all of the desired options for the task appmail as described above, the task manager can select the “Apply” button of the “Task Option” screen, to return to the “New Task screen as shown in FIG. 2C. Otherwise, to move forward, the task manager can add recipients according to the “Set Recipients” step A2e of FIG. 2B. This step is carried out when the task manager MGR selects the “Recipients” button from the “New Task” screen shown in of FIG. 2C or when the task manager MGR selects the “Recipients” button from the “Task Option” screen as shown in FIG. 2D. When the “Recipients” button is selected, a “Recipients” screen, such as that shown in FIG. 2E is presented to the task manager MGR. Using the “Recipients” screen, the task manager MGR inputs the recipients, i.e., the assigned task members MEM, for the task appmail being created. As shown in FIG. 2D, the “Recipients” screen comprises a listing of recipient records RR that indicate the names and/or e-mail addresses of the task members MEM already assigned to the task, if any. The already-assigned members can be deleted if desired by selecting the “Delete” button associated with the record RR to be deleted. The task manager MGR can select the “Add from Address Book” button and will then be presented with his/her e-mail address book from which recipients can be selected using a mouse, stylus, keyboard and/or other input device. Also, the task manager MGR can type a recipient's e-mail address into the field RF and select the “Add Manually” button to assign a recipient (task member MEM) to the task appmail being defined. When all recipients have been assigned to the task appmail, the task manager MGR can select the “Apply” button using his/her input device or can select the “Options” button to set/edit the options for the task appmail as described above in relation to FIG. 2D or can move forward by selecting the “Questions” button field to carry our step A2f of FIG. 2B.

In the step A2f, the task manager creates and/or assigns questions to the task appmail being created/defined. This step A2f is initiated when the task manager selects the “Questions” button from the “New Task” screen (FIG. 2C), the “Task Option” screen (FIG. 2D) or the “Recipients” screen (FIG. 2E). In any case, when the “Questions” button is selecting by the task manager using an input device such as a mouse, stylus, keyboard or other input device, the task manager is presented with the “Question-Summary” screen as shown in FIG. 2F.

The “Question-Summary” screen comprises a plurality of buttons that can be selected by the task MGR manager using his/her input device, including: (i) a “Task Edit” button that, when selected by the task manager, causes the “New Task” screen of FIG. 2C to be presented to the task manager; (ii) a “Recipients” button that, when selected by the task manager, causes the “Recipients” screen of FIG. 2E to be presented to the task manager; (iii) an “Options” button that, when selected by the task manager, causes the “Task Option” screen of FIG. 2D to be presented to the task manager; (iv) a “Preview” button that, when selected by the task manager, causes the task appmail, itself, to be presented to the task manager for review before sending; and (v) a “Send” button that, when selected by the task manager, causes the task appmail to be sent to the assigned task member recipients (MEM) for action as described below.

The “Question-Summary” screen (FIG. 2F) comprises a plurality of saved question records QR, each relating to a question previously constructed by the task manager and saved for later use in a task appmail. Each saved question record QR comprises a “Type” field that defines the questions as one of a select number of question types (e.g., five possible question types in the present example), a “Description” field that lists at least a beginning portion of the text of the saved question for reference, and an “Info” field that is selectable using a mouse, keyboard, stylus and/or other input device in order to obtain a full description of the saved question. To add one of the saved questions to the task appmail being composed, the task manager can double-click or otherwise select the desired saved question record QR, e.g., by highlighting the record QR and selecting the “Add” button.

If the task manager MGR desires to create a new question and assign same to an appmail, the task manager uses his/her input device to pull down the “Select Question Type” menu. When the “Select Question Type” menu is pulled down, the task manager can select therefrom one of the select predefined question types for the new question to be created and added to the task appmail. In the embodiment being described, five different predefined question types are available and include: (i) a Yes/No question to which the recipient must respond yes or no; (ii) a Numeric question to which the recipient must respond “> greater than” “< less than” or “= equal to;” (iii) a Text question to which a recipient must respond with an unstructured textual (typed) answer; (iv) a Multiple Choice—Text question to which the recipient must choose one of a plurality of predefined textual responses; and, (v) a Multiple Choice—Date/Time question to which the recipient must choose one of a plurality of predefined date and/or time responses.

When the task manager MGR selects one of the five different predefined question types from the “Select Question Type” pull-down menu, a corresponding question screen is then presented to the task manager for adding a question of the predefined type. These corresponding question screens include: (i) a “Yes/No” question screen (FIG. 2G) for defining and adding a yes/no question to the task appmail being defined; (ii) a “Numeric” question screen (FIG. 2H) for defining and adding a numeric question to the task appmail being defined; (iii) a “Text” question screen (FIG. 2I) for defining and adding to the task appmail being defined a question requiring an unstructured textual response; (iv) a “Multiple Choice—Text” question screen (FIG. 2J) for defining and adding a multiple choice question having a textual answer to the task appmail being defined; and, (v) a “Multiple Choice—Date/Time” question screen (FIG. 2K) for defining and adding a multiple choice question having a date and/or time answer to the task appmail being defined.

The “Yes/No” question screen (FIG. 2G) for defining and adding a yes/no question to the task appmail being defined comprises a text box TB into which the task manager types or otherwise inputs a textual question. The “Yes/No” question screen further comprises a default (desired) answer input section DA comprising at least “yes” and “no” (and optionally other choices such as “don't know” or “not applicable”) predefined choices PC and corresponding radio buttons RB, check-boxes or other user-selectable fields respectively associated with each predefined choice PC by which the task manager MGR can designate the correct/default (his/her desired/expected) response to the question entered in the text box TB (as described below, the choice selected by the task manager in the default answer input section DA is presented as the default answer in the task appmail as received by the task members MEM). Once the text box TB and default answer DA sections are completed by the task manager, the task manager selects the “Submit” button to send the question data to the basic application for ultimate use by the appmail engine AE in order to add the question and default response to the task appmail being defined and to return to the “Question-Summary” screen (FIG. 2F). Alternatively, if the task manager is dissatisfied with the input his/she has added to the text box TB and default answer DA sections, the “Reset” button can be selected to clear/reset the “Yes/No” question screen to start over.

The “Numeric” question screen (FIG. 2H) for defining and adding a numeric question to the task appmail being defined comprises a text box TB into which the task manager MGR types or otherwise inputs a textual question. The “Numeric” question screen further comprises a default (desired) answer input section DA comprising at least “> Greater than” and “< Less than” and “= Equal to” predefined choices PC and corresponding radio buttons RB, check-boxes or other user-selectable fields respectively associated with each predefined choice PC by which the task manager MGR can designate the correct/default (his/her desired/expected) response to the question entered in the text box TB, which will also be the default answer presented to a task member recipient MEM of the task appmail. Once the text box TB and default answer DA sections are completed by the task manager, the task manager selects the “Submit” button to send the question data to the basic application for use by the appmail engine AE in order to add the question and correct response to the task appmail being defined and to return to the “Question-Summary” screen (FIG. 2F). The “Reset” button as described above is also available if needed to clear/reset the “Numeric” question screen.

The “Text” question screen (FIG. 2I) is used by the task manager MGR to define and add to the task appmail a question that requires an unstructured textual answer. The “Text” question screen comprises at least one text box into which the task manager types or otherwise inputs a textual question. As shown, the “Text” question screen comprises first and second text boxes TB1,TB2. The first text box TB1 is intended for short (1-line) questions while the second text box TB2 is intended for longer (multi-line) questions. Of course, either one of these text boxes TB1,TB2 can be included as part of the Text Question screen without the other in an alternative embodiment. After the task manager has entered a question in either of the text boxes TB1,TB2, the task manager selects the “Submit” button to send the question data to the basic application for use by the appmail engine AE in order to add the question to the task appmail being defined and to return to the “Question-Summary” screen (FIG. 2F). Alternatively, if the task manager is dissatisfied with the input his/she has added to a text box TB1,TB2, the task manager can select the “Reset” button to clear/reset the “Text” question screen.

The “Multiple Choice—Text” question screen (FIG. 2J) for defining and adding a multiple choice question having a textual answer to the task appmail being defined comprises a text box TB into which the task manager MGR types or otherwise inputs a textual question. The “Multiple Choice—Text” question screen further comprises a default (desired) answer input section DA comprising a plurality of text choice input boxes TC into which the task manager types or otherwise inputs respective textual responses to the question entered in the text box TB. The default answer section DA further comprises a corresponding plurality of radio buttons RB, check-boxes or other user-selectable fields respectively associated with each text choice input box TC by which the task manager MGR can designate which of the text choice input boxes includes the correct/default (his/her desired/expected) response to the question entered in the text box TB, which will also be the default answer presented to a task member recipient MEM of the task appmail. Once the text box TB and default answer DA sections are completed by the task manager, the task manager selects the “Submit” button to send the question data to the basic application for use by the appmail engine AE in order to add the question and correct response to the task appmail being defined and to return to the “Question-Summary” screen (FIG. 2F). The “Reset” button as described above is also available if needed to clear/reset the screen.

The “Multiple Choice—Date/Time” question screen (FIG. 2K) for defining and adding to the task appmail being defined a multiple choice question having a date and/or time answer comprises a text box TB into which the task manager MGR types or otherwise inputs a textual question. The Multiple Choice—Date Question screen further comprises a default (desired) answer input section DA comprising a plurality of date/time choice input records DTC each preferably comprising both a date choice input box DC into which the task manager can type or otherwise input a date choice and a related time choice input boxes MC into which the task manager can type or otherwise input a time choice (only one of the boxes DC,MC need be filled in by the task manager). The default answer section DA further comprises a plurality of radio buttons RB, check-boxes or other user-selectable fields respectively corresponding with the date/time choice input records DTC by which the task manager MGR can designate which of the date/time choice input records DTC includes the correct/default (his/her desired/expected) response to the question entered in the text box TB, which will also be the default answer presented to a task member recipient MEM of the task appmail. Once the text box TB and default answer DA sections are completed by the task manager, the task manager selects the “Submit” button to send the question data to the basic application for use by the appmail engine AE in order to add the question and correct response to the task appmail being defined and to return to the “Question-Summary” screen (FIG. 2F). The “Reset” button as described above is also available if needed to clear/reset the screen.

Once all questions have been defined according to step A2f of FIG. 2B, the task manager MGR can optionally preview the task appmail he/she has just defined according to step A2g of FIG. 2B. In the step A2g, the task manager selects the “Preview” button from the New Task screen (FIG. 2C) or another screen such as the “Task Option” screen (FIG. 2D) or “Question-Summary” screen (FIG. 2F). In any case, once the “Preview” button is selected, the actual task appmail just defined in displayed to the task manager for review in advance of sending same to the assigned task member recipients MEM.

To complete the process of defining a new task appmail, the task manager selects the “Send” button from “New Task” or “Task Option” or “Recipients” or “Question-Summary” screens (FIGS. 2C,2D,2E,2F). Once the “Send” button is selected, all of the data entered by the task manager MGR to define the new task appmail according to steps A2a-A2f of FIG. 2B (referred to herein as the “appmail definition data”) is submitted as part of a request to the appmail engine AE in order for the new task appmail to be derived and sent to the assigned task member recipients MEM.

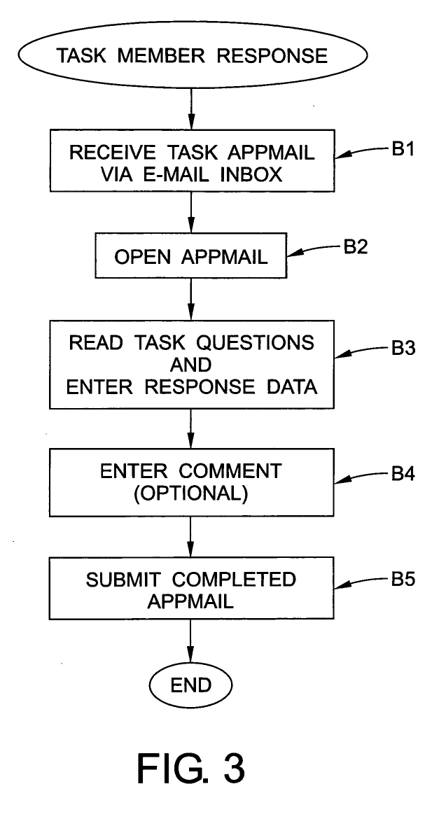

FIG. 3 is a flow chart that discloses the process by which a task member MEM receives and responds to a task appmail. In a step B1, the task member receives the task appmail in his/her e-mail inbox and, in a step B2, the task member clicks or otherwise selects the task appmail to open same in the same fashion as a conventional e-mail.

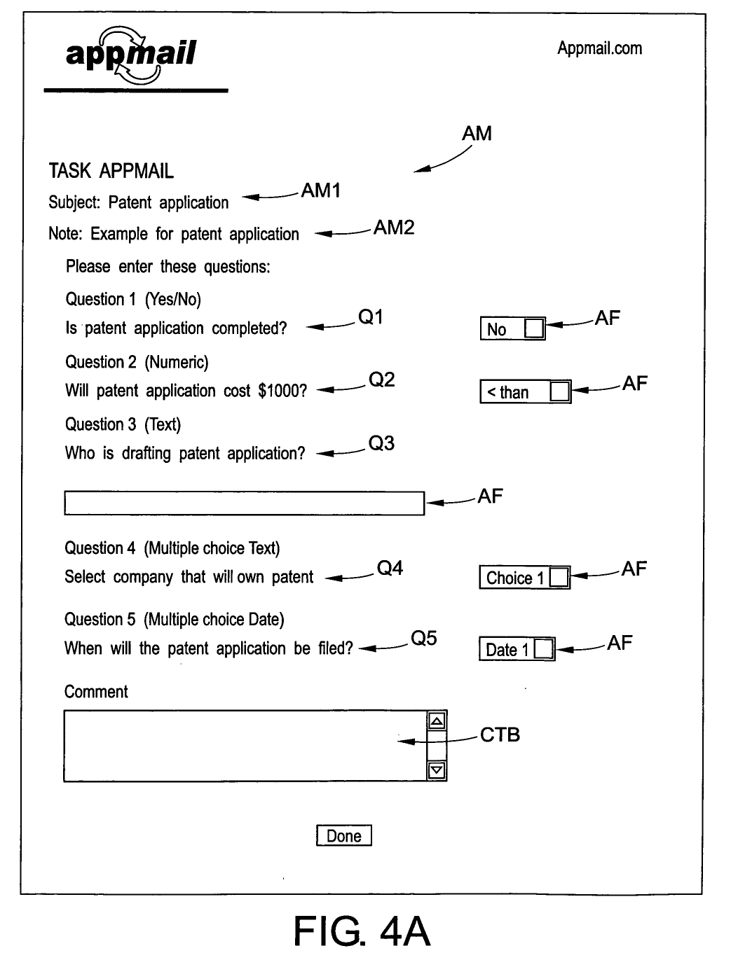

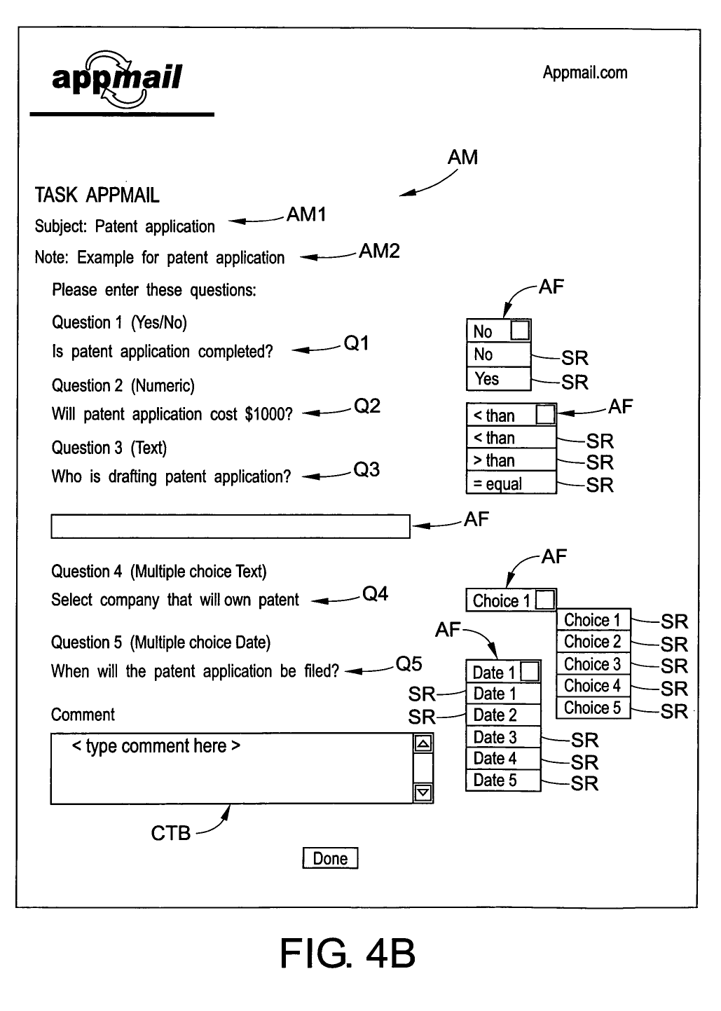

As described in full detail below, the task appmail is preferably defined as an multimime e-mail including the HTML appmail. An example of a task appmail as displayed on the task member's computer screen when opened via e-mail (or a browser or other suitable application) is shown at AM in FIG. 4A. The task appmail AM comprises the subject AM1 and note AM2 as entered by the task manager MGR according to the above-described method.

The task appmail AM further comprises the questions Q1,Q2,Q3,Q4,Q5 defined/entered by the task manager according to step A2f of FIG. 2B as described above in relation to FIGS. 2F-2K. Each question Q1-Q5 comprises a respective answer field AF. In the case of a “Yes/No” question Q1, a “Numeric” question Q2, a “Multiple Choice—Text” question Q4 or a “Multiple Choice—Date/Time” question Q5, the answer field AF comprises a structured response data entry field comprising a plurality of predefined structured responses that are selectable by the task member recipient MEM of the task appmail AM. In the illustrated appmail AM, the structured response data entry fields AF are pull-down menus operable via mouse, stylus, keyboard and/or other input device and that display a plurality of different predefined structured responses SR to the user when “pulled-down” or expanded by the user as shown in FIG. 4B. The user can then select the desired structured response SR using the mouse or other input device. Of course, the predefined structured responses SR associated with the “Yes/No” and “Numeric” questions Q1,Q2 are the predefined choices PC shown on the screens of FIGS. 2G,2H, respectively, and the structured responses SR for the “Multiple Choice—Text” and Multiple Choice—Date/Time” questions are the choices entered by the task manager in the default answer sections DA of the screens shown in FIGS. 2J,2K, with the default answer for the appmail AM being that designated as the default answer by the task manager using the radio buttons RB or other selectable fields of the default answer DA section of the question definition screens.

The question Q3 of the appmail AM is a question that requires free-form textual input via typing or other means and, as such, the answer field AF associated therewith is simply a text box to receive text data.

It should be noted that a task appmail defined according to the present invention includes at least one question Q1,Q2,Q4,Q5 having a structured response data answer field associated therewith. Unlike a conventional e-mail, an appmail defined according to the present development must have at least one question that can be answered by the recipient by selecting a desired predefined structured response from the structured response choices SR of the answer field AF.

Returning to FIG. 3, in a step B3, the task member MEM reads the questions Q1,Q2,Q4,Q5 and selects a structured response choice SR to each via answer fields AF associated respectively with these questions using the pull-down menu or other user-selectable fields such as check-boxes, highlighting, etc. The task member also reads the question Q3 and types or otherwise enters a textual response in the answer field AF associated therewith.

The appmail AM (FIG. 4A) preferably comprises a comment text box CTB and, in an optional step B4, the task member types or otherwise enters a text comment in same.

The task appmail AM (FIG. 4A) is deemed a completed appmail when the task member has answered all (or a required minimum percentage of) questions Q1-Q5. In a step B5, the task member submits the completed appmail to the appmail engine AE directly or via the basic application by selecting the “Done” button (FIG. 4A).

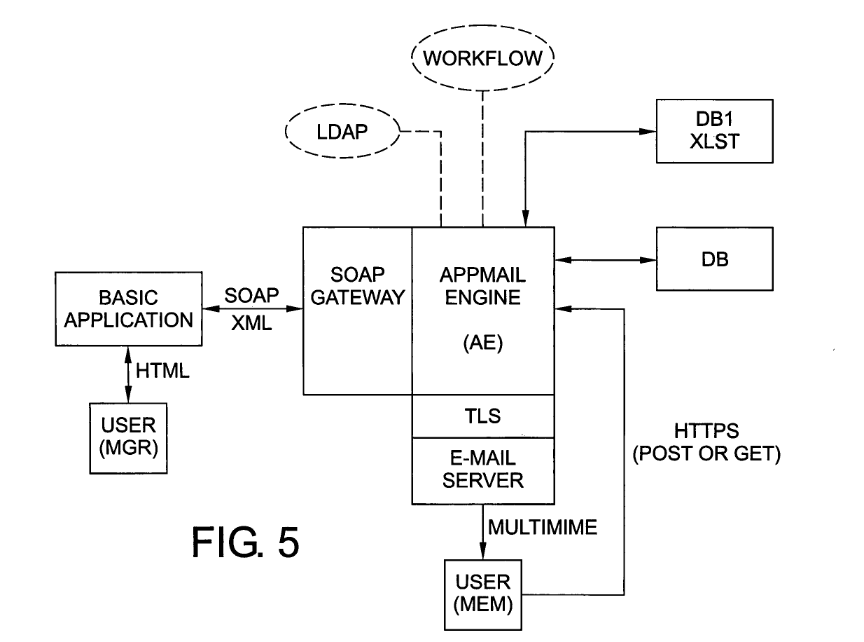

FIG. 5 is a diagram that generally illustrates the process of generating and using an appmail AM in accordance with the present invention. As noted above in connection with FIG. 2, step A2, the task manager MGR uses the basic application, such as an html/xml web site or other basic application to define a new task appmail (e.g., the task appmail AM of FIG. 4A) using his/her browser. The basic application in the present example comprises an html/xml website server that presents the appmail definition screens of FIGS. 2A,2C,2D,2E,2F,2G,2H,2I,2J,2K to the task manager MGR, and the basic application receives input from the task manager to define the task appmail as the task manager enters data into the appmail definition screens as described according to steps of FIG. 2B. As noted above, all of the data entered by the task manager to define the new task appmail as shown in FIG. 2B is referred to herein as “appmail definition data.”

The basic application generates a SOAP request based upon the appmail definition data entered by the task manager MGR and sends the SOAP request to the appmail engine AE through a SOAP gateway. This occurs, and the appmail engine AE receives a SOAP request for a new task appmail, such as the task appmail AM of FIG. 4A, from the basic application (it is noted again that the appmail engine AE can be integrated into the basic application or separate therefrom) when the task manager selects one of the various “Send” buttons from the various screens of FIGS. 2C-2F. The request for a task appmail includes the appmail definition data. The appmail engine AE can also access the database DB to obtain addition data to be used to define the new appmail, for example, the task manager's stored font/color/layout and other preferences, etc.

Predefined task appmail templates and/or rules are stored in an appmail template database such as the database DB or another database such as DB1 in FIG. 5. The appmail engine AE prepares the new task appmail by combining the appmail definition XML data with any data retrieved from the database DB and the corresponding predefined appmail XLST template/rules. The appmail engine AE preferably spoofs the “From” field of the appmail being constructed so that the appmail will appear to a recipient task member MEM in his/her e-mail inbox as having been sent by a particular user (e.g., the task manager MGR who initiated the task appmail) instead of the appmail engine AE.

Once the appmail AM is constructed, the appmail engine AE sends same to the assigned task member recipients MEM via e-mail through a mail server using a secure method such as transport layer security (TLS). As noted, the recipient user will open the appmail via browser, e-mail program, etc. and will read the question(s) and provide the requested structured and unstructured response data in the answer field(s) AF.

The completed appmail (i.e., the task appmail including any structured and unstructured response data and any comment entered in the text box CTB) is then sent from the task member MEM back to the appmail engine AE when the task member user MEM selects the “Done” button of the appmail. More particularly, the completed appmail is securely input directly to the appmail engine AE using an https post or an https get method.

The appmail engine AE then extracts the structured and unstructured response data from the answer fields AF for all questions of the of the completed appmail and stores the extracted response data in the database DB for storage and reporting and use as described herein.

With continuing reference to FIG. 5, in the illustrated embodiment, the appmail engine AE stores the appmail forms/templates as XSLT based data. To request a new appmail, the basic application generates a SOAP message that contains a transaction which includes one or more appmail requests and sends same to the appmail engine AE. Each appmail request is a set of XML data including the appmail definition data defined by the task manager using the underlying basic application program. The SOAP message preferably includes additional data to define the desired appmail transaction such as the definition of a valid response (e.g., whether an incomplete response is valid), the percentage of valid responses required, and other parameters such as what action to take (e.g., re-send, none) in the event an invalid completed appmail is received. The appmail engine AE logs the overall transaction and all requests included therein in a database DB.

Each XML request defined as part of the SOAP message received by the appmail engine AE is translated into the required appmail. More particularly, the appmail engine AE integrates the XML request data from the SOAP message, including the appmail definition data, with the appropriate XSLT-based appmail form/template that was previously stored by the appmail engine AE in the database DB or DB1. The resulting appmail is preferably defined as multimime email including the HTML appmail file, and the engine AE sends the appmail to the designated recipients via e-mail.

The task member recipients MEM of the appmail complete the appmail by selecting structured and entering optional unstructured data into the answer fields AF and returning the completed appmail to the appmail engine via http/https to an awaiting servlet. The appmail engine AE receives the completed appmail and re-constitutes same into XML. The XML data representing structured and unstructured response data entered by the recipient of the APPMAIL and other associated data are stored in the database DB and logged against the relevant request from which the appmail was generated.

Those of ordinary skill in the art will recognize that the appmail engine AE is a middleware application built on services oriented architecture(SOA). Some of the fundamental services catered by appmail engine AE includes transaction/request processing, generating an appmail, resend, logging, application validation, exception handling. The appmail engine AE comprises or is connected to a SOAP (Simple Object Access Protocol) gateway which is entry point for the appmail engine. Once a SOAP request is received from the basic application, the appmail engine AE performs basic security checks such as decode and check etc. SOAP requests can be received over secure transport layer (SSL). Once a security check is completed, the appmail engine AE has provision to do authentication/authorization by interfacing with LDAP and workflow databases/processes. Each SOAP request will result in the appmail engine AE generating one or more appmails for task member recipients MEM. XML request data are converted into equivalent HTML data for the appmail using XSLT. HTML data generated thereafter will be embedded in email body and will be sent to recipient via multimime e-mail. The appmail engine interfaces with a mail server to send these emails in secure way such as TLS. The appmail is resent in case the recipient MEM does not respond within a predefined time. The appmail engine AE notifies the basic appmail (and thus the task manager MGR) when an appmail has not been responded to in a timely manner and becomes past due SOAP in a secure way.

The appmail engine is a purely Java (J2EE) compliant engine which can run on any J2EE compliant server, connecting to any relational database such as the database DB with minimum configuration changes.

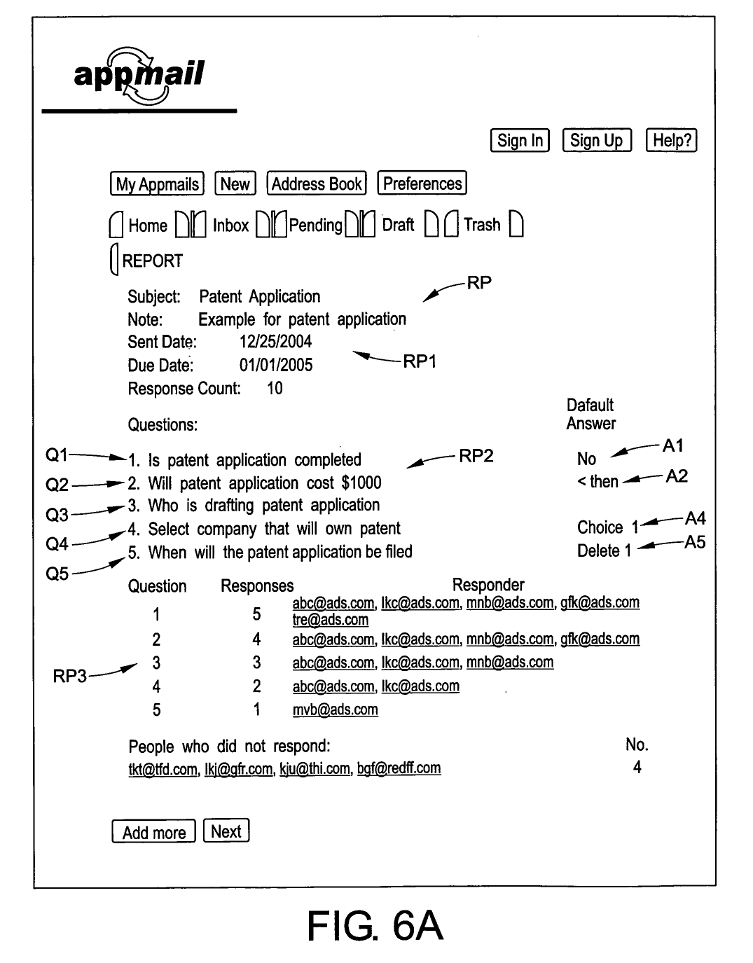

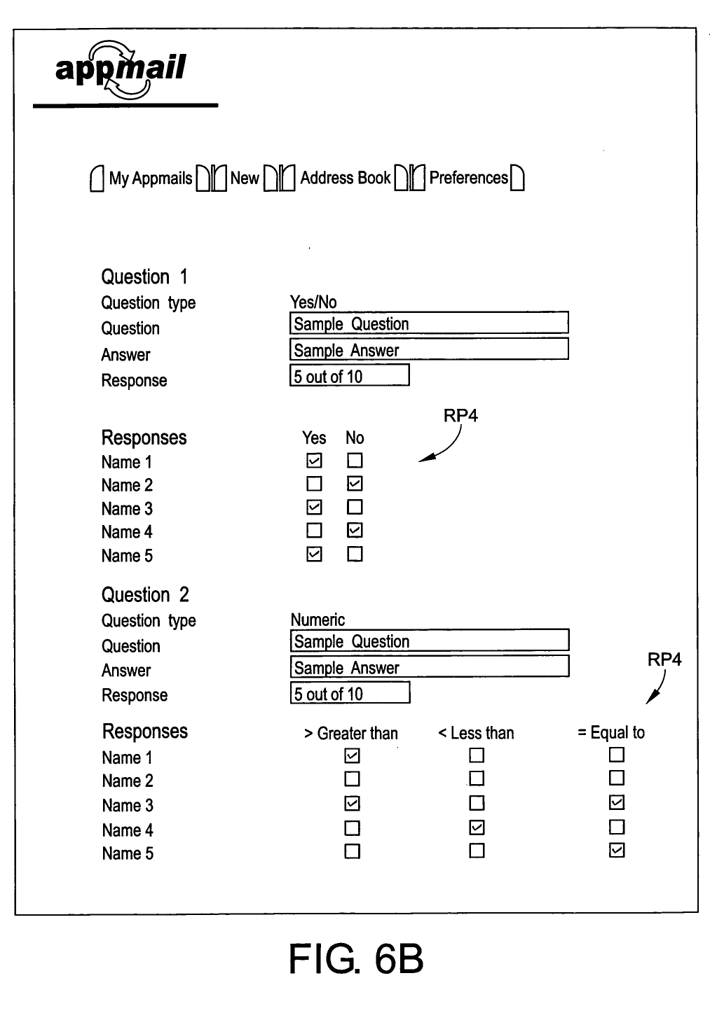

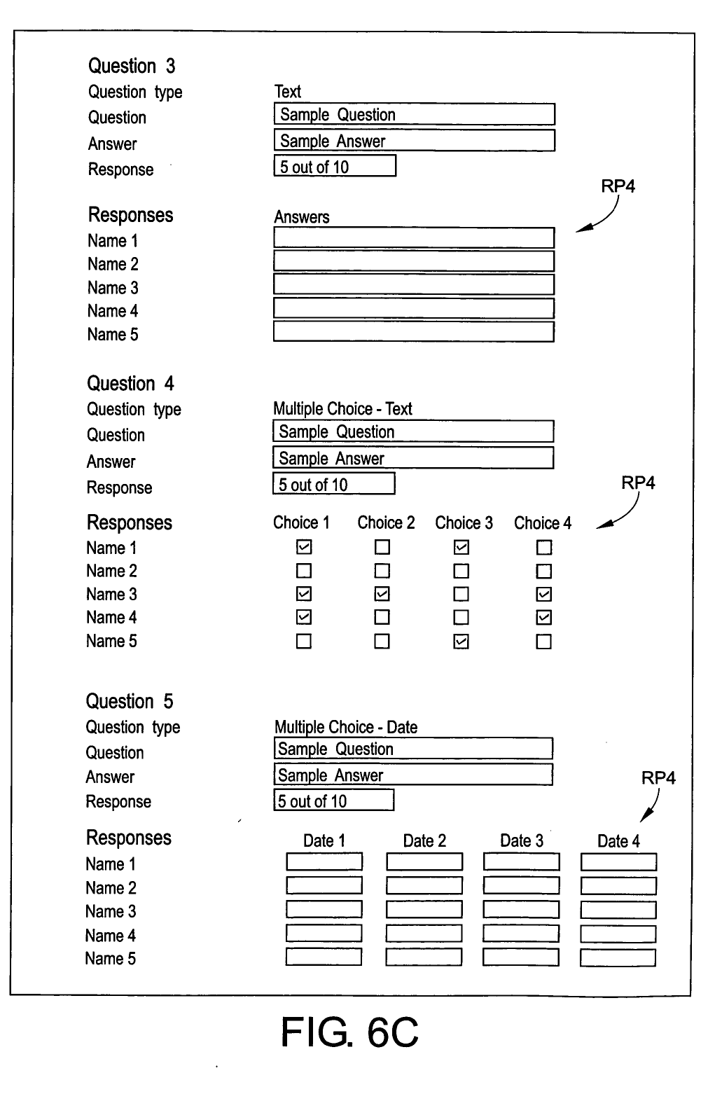

The appmail engine AE derives a task report and provide same to the task manager MGR through the basic application or directly by e-mail, web page or otherwise. As part of the appmail definition process of FIG. 2B, the task manager selects an html and/or a spreadsheet (e.g., Excel) format for the task report (see FIG. 2D—“Report as” field). In particular, the appmail engine AE uses the structured and unstructured response data extracted from the answer fields AF of the completed appmails, along with other available data (e.g., sender data, data/time data, statistical data derived from the response data, etc.) to generate the required report. FIGS. 6A,6B and 6C illustrate one example of an html task report RP generated by the appmail engine AE.

The task report RP comprises a header RP1 that includes the “Subject” and “Note” data of the corresponding task appmail, along with a “Sent Date” field that indicates the date when the task appmail was sent and a “Due Date” field reflecting the due date assigned by the task manager as part of the appmail definition data. The header RP1 further comprises a “Response count” field that provides data the describe the number of task members MEM from whom a completed appmail has been received.

The task report RP further comprises a question summary section RP2 that sets forth all questions Q1-Q5 of the related task appmail AM and also the respective default answers A1,A2,A4,A5, if any, (note that question Q3 requires a free-form textual response so no default answer is listed).

The task report RP further comprises a response summary section RP3 that provides a count of the responses to each question and a listing of the responding task members MEM to each question, and also an overall count and listing of the non-responding task members MEM.

The report RP comprises an “Add more” button that can be selected by the task manager MGR to add additional task member recipients MEM to the task appmail according to step A2e of FIG. 2B using the screen shown in FIG. 2E. The task appmail will then be sent to these added recipients when the task manager selects the “Send” button from the screen shown in FIG. 2E.

All following pages of the report RP as shown in FIGS. 6B and 6C are displayed to the task manager MGR when he/she selects the “Next” button. The report RP further comprises a response detail section RP4 for each question Q1-Q5 of the task appmail. For each question Q1-Q5, the response detail section RP4 comprises a listing of the question type, a repeat of the question, the default answer, the number of responses, and the actual responses of each responding task member MEM.

As such, it can be seen that a task manager viewing the task report RP relating to a particular task appmail will have a clear and quick understanding as to the status of the related task. This is especially true with respect to the questions Q1,Q2,Q4,Q4 having structured response data only, given that the task members MEM must respond with one of the structure response choices SR which facilitates generation of a useful report in that the responses can then be easily mapped, analyzed and displayed.

The invention has been described with reference to preferred embodiments. Modifications to the invention will occur to those of ordinary skill in the art upon reading this specification. It is intended that the claims be construed literally and/or according to the doctrine of equivalents as including all such modifications and alterations to the fullest possible extent.

1. A task management method comprising:
receiving appmail definition data relating to a task from a task manager, said appmail definition data comprising question data defining a question relating to a task and structured response data defining a plurality of different structured responses to said question;
generating a task appmail based upon said appmail definition data received from said task manager, said task appmail defining a questionnaire including said question and said plurality of different structured responses, wherein said task appmail comprises a data file that defines said questions and said plurality of structured responses to said question, and wherein said data file further defines a plurality of different user-selectable fields associated respectively with said plurality of structured responses when said task appmail is displayed to a user on a computer screen;
sending said task appmail to a task member by e-mail;
receiving a completed task appmail from said task member, said completed task appmail comprising response data that represent said one of said different structured responses to said question selected by said task member using one of said plurality of different user-selectable fields;
saving said response data in a database;
using said response data to generate a task report for said task manager.

2. The task management method as set forth in claim 1, wherein said step of receiving appmail definition data from a task manager comprises:
presenting an HTML appmail definition webpage to said task manager;
receiving said appmail definition data from said task manager via said HTML webpage.

3. The task management method as set forth in claim 2, wherein said appmail definition data further comprise at least a plurality of:
subject data that define a subject of said task appmail;
note data that define a note relating to said task appmail;
due date data that define a due date for said task member to respond to said task appmail;
recipient data that define an e-mail address for said task member.

4. The task management method as set forth in claim 3, wherein said structured response data of said appmail definition data comprise default answer data that define an expected default answer to said question.

5. The task management method as set forth in claim 4, wherein said task appmail comprises a default answer section comprising said plurality of different structured responses, wherein one of said plurality of different structured responses is indicated as a default answer to said question.

6. The task management method as set forth in claim 1, wherein said steps of generating and sending a task appmail comprise:
receiving a SOAP request comprising XML data defining said appmail definition data;
using said XML data and XSLT data to define said task appmail as an HTML file;
defining a multimime e-mail comprising said HTML task appmail;
sending said multimime e-mail to said task member.

7. The task management method as set forth in claim 6, wherein said step of sending said multimime e-mail to said task member comprises a secure e-mail method using transaction layer security (TLS).

8. The task management method as set forth in claim 1, wherein said step of receiving a completed task appmail from said task member comprises using an https post method or an https get method to input said response data directly to a java servlet.

9. The task management method as set forth in claim 1, wherein said step of using said response data to generate a task report for said task manager comprises generating a HTML report comprising report question data that define said question and report response data that define said task members response to said question.

10. The task management method as set forth in claim 1, wherein said structured response data received from said task manager as part of said appmail definition data comprise structured response data input by said task manager to define structured responses that are responsive to said question.

11. The task management method as set forth in claim 10, wherein said structured response data entered by said task manager include at least one of: time data representing multiple time related structured responses to said question, date data representing multiple date related structured responses to said question, text data representing multiple textual structured responses to said question.

12. The task management method as set forth in claim 1, wherein said structured response data received from said task manager as part of said appmail definition data comprise predefined structured response data that represent structured responses that are responsive to said question.

13. The task management method as set forth in claim 12, wherein said predefined structured response data include at least one of: “yes” and “no” data respectively representing “yes” and “no” responses to said question; “> greater than” and “< less than” and “= equal to” data respectively representing “> greater than” and “< less than” and “= equal to” responses to said question.
